(19) United States
(12) Patent Application Publication
(10) Pub. No.: US 2006/0112695 A1
(43) Pub. Date: Jun. 1, 2006

(54) Motor vehicle comprising an internal combustion engine and an auxiliary power unit

(76) Inventors: Achim Neubauer, Sinzheim-Vormberg (DE); Thomas Heid, Renchen-Ulm (DE)

Correspondence Address: MICHAEL BEST & FRIEDRICH, LLP, 100 E WISCONSIN AVENUE, MILWAUKEE, WI, 53202, US

(21) Appl. No.: 10/541,831

(22) PCT Filed: Sep. 25, 2003
(86) PCT No.: PCT/DE03/03204

§ 371 Date: Jul. 12, 2005

(30) Foreign Application Priority Data
Jan. 17, 2003 (DE) 103016090

(51) Int. Cl. F02D 25/00; H01M 8/12

(52) U.S. Cl. 60/714; 429/26

(57) ABSTRACT

The invention starts with a motor vehicle with an internal combustion engine (12) and an auxiliary power supply device, which includes a fuel cell (50), wherein energy flows and/or media flows of the internal combustion engine (12) and the fuel cell (50) are coupled with one another, in which a cooling and heating circuit (10) is provided. It is proposed that the cooling and heating circuit (10) features a first partial circuit (26) and a second partial circuit (44), of which the first (26) is allocated to the internal combustion engine (12) and the second (44) to the fuel cell (50), and that the two partial circuits (26, 44) are connected with one another via a supply line (62) having a supply valve (66) and via return line (64) having a return valve (68).

The invention started with a motor vehicle with an internal combustion engine and an auxiliary power supply device in accordance with the pre-characterizing clause of claim 1.

### PRIOR ART

In several operating states of the motor vehicle, for example before or during a cold start, during short-distance traffic or during long travel down a grade, a heat yield in the cooling water via the internal combustion engine itself is not given or is insufficient, in particular if the efficiency of the internal combustion engine is very good and consequently there are low heat losses. Consequently, the internal combustion engine reaches its optimal temperature in a short time or else much later, which leads to increased fuel consumption and to increased exhaust emissions.

In addition, in the case of low outside temperatures, considerable amounts of heat are required to de-ice the vehicle windows or to heat the vehicle passenger compartment and therefore guarantee adequate driving safety and good driving comfort. Currently, this problematic situation is being solved predominantly with chemical or electric auxiliary heaters. Although chemical auxiliary heaters, e.g., burners, offer high comfort due to the possibility of heating the internal combustion engine even at a standstill, they are relatively expensive. Electric auxiliary heaters in accordance with the principle of resistance heating are limited in terms of performance, because not as much current as desired can be made available by the generator and the battery.

A motor vehicle with an internal combustion engine and an auxiliary power supply device, also called APU (Auxiliary Power Unit), for electrical consumers on board the motor vehicle is known from EP 1 203 697 A2, which includes a fuel cell system and a battery coupled to it. This device increases the electrical power of the motor vehicle and creates the possibility of operating a greater number of electric consumers independent of the operation of the internal combustion engine. The internal combustion engine and the fuel cell system are attached to a common cooling and heating circuit, in which a cooler simultaneously cools the internal combustion engine and the fuel cell system. This is fostered by the different peak cooling capacities that are required for the internal combustion engine during driving operation and for the fuel cell system when the vehicle is at a standstill, e.g., during the starting phase or when operating an independent vehicle heater.

Significantly, energy and/or media flows that are generated in the process are coupled with one another in that, e.g., the exhaust gas of the internal combustion engine is guided through a system, which includes a heat exchanger and/or an exhaust gas catalyzer. This system is thermally coupled with the fuel cell system. As a result, it is possible to preheat by means of the exhaust gas heat. During the operation of the internal combustion engine, the fuel cell system is kept at an operating temperature and therefore is available in a short time with an increased energy demand. On the other hand, it can be preheated with the waste heat of the fuel cell system of the exhaust gas catalyzer before the internal combustion engine is started so that its harmful emissions are minimized during the starting phase. Moreover, the fuel cell system is thermally connected with an air conditioner and/or an independent vehicle heater so that the waste heat thereof can be used to heat the passenger compartment if need be.

### ADVANTAGES OF THE INVENTION

In accordance with the invention, a cooling and heating circuit features a first and a second partial circuit, of which the first is allocated to the internal combustion engine and the second to the fuel cell. The two partial circuits are connected with one another, and namely via a supply line having a supply valve and via return line having a return valve. In addition to the fuel cell, a heater heat exchanger of an air conditioner for the vehicle passenger compartment, an engine oil heat exchanger and a transmission oil heat exchanger are arranged in the second partial circuit. Before starting the internal combustion engine at low outside temperatures, the second partial circuit assumes the cooling of the fuel cell. Due to a plurality of electrical consumers to be supplied in standby operation of the motor vehicle, the fuel cell is subjected to a peak load in precisely this operating state so that relatively a lot of waste heat generates when operating the fuel cell. This waste heat is transported via the coolant of the second partial circuit on a short path to an aggregate with a demand for heat, e.g., the heater heat exchanger of the air conditioner. Because of this arrangement, energy to de-ice the vehicle windows as well as to air condition the vehicle passenger compartment is advantageously available very quickly and effectively. In order to be able to cover a maximum demand for energy and to improve the warm start behavior of the fuel cell, an auxiliary heater can also be expediently arranged in the second partial circuit, which also gives off heat to the coolant if need be. Due to the two partial circuits, the different, namely lower temperature level of the fuel cell as compared to the internal combustion engine can also be taken into consideration in an advantageous manner, thereby avoiding damage to the fuel cell from overheating.

As soon as the desired temperature of the vehicle passenger compartment is reached or if the internal combustion engine is supposed to be started, a controllable valve opens another line of the second partial circuit to the engine oil heat exchanger for the engine oil of the internal combustion engine and to the transmission oil heat exchanger so that these media can also be heated in a purposeful manner via the coolant of this partial circuit. In doing so, the regulation of the heat flows is oriented in any case according to a priority demand and can also occur via both a climate control device or via a time default of an engine control. It is known that prematurely heating the engine or transmission oil reduces fuel consumption. In addition to saving fuel, prematurely heating the engine or transmission oil shortens the starting time of the internal combustion engine and increases its service life since lower temperature fluctuations occur during the starting phase.

The engine oil heat exchanger and the transmission oil heat exchanger are connected in parallel and integrated into the second partial circuit, wherein the supply line and the return line, which connect the first partial circuit with the second partial circuit, are attached to the second partial circuit in front of or behind the oil coolers. The inflow and outflow of the coolant in this cooling branch is also adjusted in terms of demand via control valves in accordance with the corresponding defaults of the climate control and/or internal combustion engine control. Thus, in the case of an increased demand for cooling power, e.g., in driving operation, the engine oil heat exchanger and the transmission oil heat exchanger are supplied with coolant from the partial circuit of the internal combustion engine via the opening of the valves in the supply and return lines, while before and during starting the internal combustion engine, it is primarily coolant from the fuel cell and/or the auxiliary heater that flows through them for preheating. Even in this case, the heat yield is transported to the coolant either at needed locations or given off to the environment via a cooler attached in this partial circuit. =p The lubricating oil of the internal combustion engine and the transmission oil are each conveyed to the engine oil heat exchanger or the transmission oil heat exchanger via an electrically driven pump. In addition, an electrically driven auxiliary pump is arranged in the second partial circuit to convey the coolant. Since these pumps can be operated in standby operation independent of the internal combustion engine via the motor vehicle's onboard network, their use advantageously facilitates the preheating of both the engine and transmission oil as well as the internal combustion engine and the transmission itself before starting. Because of the lower viscosity of the heated oil, starting the internal combustion engine, particularly at low ambient temperatures, is improved, even if the temperature of the internal combustion engine is raised only insignificantly. In order to be able to heat the vehicle passenger compartment at the same time, the coolant flow of the heater heat exchanger is also regulated via a heater valve than can be triggered electrically.

When using de-ionized water, which is currently used preferentially as a coolant for fuel cells due to its property of non-conductivity, the cooling system of the fuel cell is embodied as a closed system in the second partial circuit. In this embodiment, along with the fuel cell and an auxiliary pump, it features special intermediate heat exchangers, which are responsible for de-coupling the different cooling media and must be designed in stainless steel due to the material compatibility with de-ionized water. The engine oil heat exchanger, the transmission oil heat exchanger and the heater heat exchanger can be manufactured of conventional materials. The special intermediate heat exchangers made of stainless steel can be advantageously arranged as desired in the engine compartment and be linked with the various media flows that must be preheated.

### DRAWINGS

Additional advantages are yielded from the following description of the drawings. Exemplary embodiments of the invention are depicted in the drawings. The drawings, the description and the claims contain numerous features in combination. The person skilled in the art will also observe individual features expediently and combine them into meaningful, additional combinations.

The drawings show:

FIG. 1 A schematic representation of a cooling and heating circuit of a motor vehicle with an auxiliary power supply device

FIG. 2 A variation of FIG. 1

### DESCRIPTION OF THE EXEMPLARY EMBODIMENTS

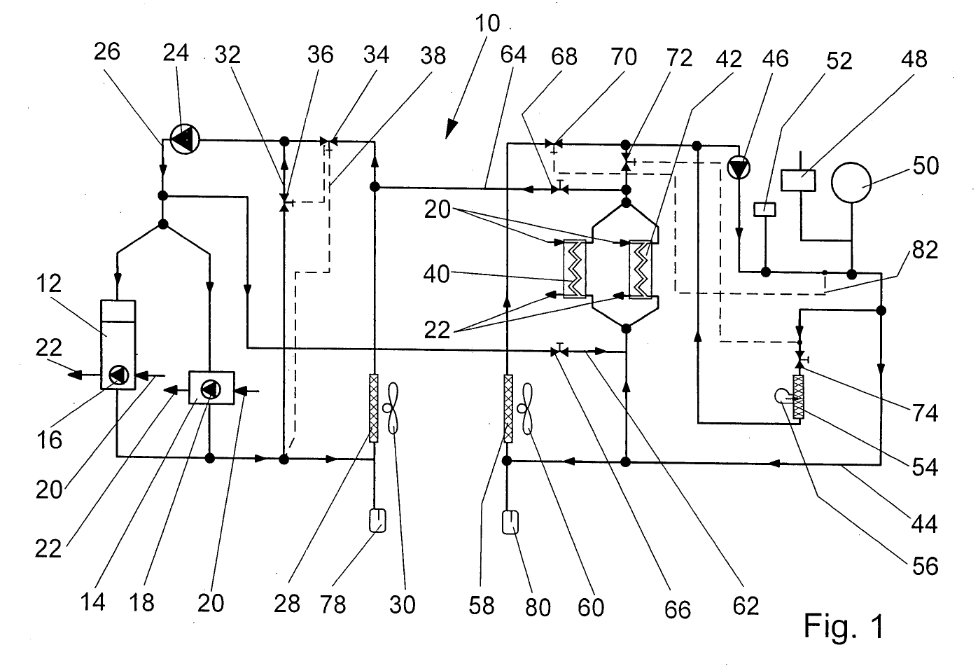

An internal combustion engine 12 and a transmission 14 of a motor vehicle are attached to a first partial circuit 26 of a cooling and heating circuit 10, in which a coolant pump 24 conveys a coolant (FIG. 1). The pump 24 can be driven by a controllable electric motor or mechanically by the internal combustion engine 12, if it has a device to adjust the conveying capacity. It conveys the coolant from the internal combustion engine 12 via a first coolant path 32, a bypass line, directly back to the internal combustion engine 12 and the transmission 14. Only very little heat is withdrawn from the coolant via the bypass line 32 so that the internal combustion engine 12 and the transmission 14 quickly reach an optimal operating temperature. As a result, less fuel is used with lower harmful emissions.

Provided parallel to the bypass line 32 is a second coolant path to a cooler 28, which cooperates with a ventilator 30 and withdraws excess heat from the coolant. Moreover, a connection to a compensating tank 78 for the coolant is arranged in the area of the cooler 28. A thermostatic valve 34 in the bypass line 32 and a thermostatic valve 36 in the coolant branch to the cooler 28 regulates the coolant flow to the cooler 28 and/or to the bypass line 32. To do so, the valves 34 and 36, which can also be combined into a two-way or three-way valve, receive defaults from a climate or engine control (not shown) via a signal line 38.

An electrically driven engine oil pump 16 and an electrically driven transmission oil pump 18 convey the engine oil or the transmission oil to a engine oil heat exchanger 40 or a transmission oil heat exchanger 42. They can be operated independently of the internal combustion engine 12 from the electrical onboard network of the motor vehicle. The oil inlets of the pumps 16, 18 and the oil heat exchangers 40, 42 are designated with 20 and the outlets with 22. The engine oil heat exchanger 40 and the transmission oil heat exchanger 42 are allocated to a second partial circuit 44 of the cooling and heating circuit 10, which preferentially takes over the cooling of a fuel cell 50. In the case of independent vehicle air conditioning, the fuel cell 50 supplies the onboard network of the motor vehicle in connection with a switching element 48. Thermal energy is generated during the operation of the fuel cell 50, which is transported via the coolant of the second partial circuit 44 on a short path to the engine oil heat exchanger 40 and the transmission oil heat exchanger 42. The heat exchangers 40 and 42 then transfer the energy to the engine or transmission oil so that these media can be heated before the internal combustion engine 12 is started. As a result, the starting procedure is eased and the aggregates are quickly brought to their optimum operating temperatures.

In order to make it possible to simultaneously heat the passenger compartment of the vehicle before starting the internal combustion engine 12, a heater heat exchanger 54 and a heater fan 56 are arranged in another branch of the second partial circuit 44. The heat yield also takes place in this case via the coolant. If the amount of heat given off by the fuel cell 50 is not sufficient, an auxiliary heater 52 can be connected temporarily via a switching element 48. If, on the other hand, the heat yield in the partial circuit 44 exceeds the demand, the excess heat can be given off to the environment via an auxiliary cooler 58 with an auxiliary ventilator 60. As a result, the second partial circuit 44 can operate largely self-sufficiently in standby operation of the internal combustion engine 10. In addition, a compensating tank 80 is provided in the partial circuit 44 in order to balance out the temperature-induced volume changes in the coolant. The coolant is conveyed in the partial circuit 44 independently of the internal combustion engine 12 by means of an electrically driven auxiliary pump 46, wherein the valves 70, 72 and 74 regulate the coolant flows in the individual branches. In this case, regulation is always oriented to a priority demand, which is transmitted via a signal line 82 to the heater valve 74 as well as to the thermostatic valves 70 and 72 via defaults of a climate and engine control.

A supply line 62 having a supply valve 66 and a return line 64 having a return valve 68 connect the first partial circuit 26 with the second partial circuit 44. Using this connection, in cases of need, e.g., when the motor vehicle is in driving operation, coolant from the first partial circuit 26 can reach the engine oil heat exchanger 40 and the transmission oil heat exchanger 42 in order to guarantee the required cooling capacity just via the cooler 28 or to keep the fuel cell 50 at operating temperature or in standby operation to preheat the internal combustion engine 12 via the coolant and the transmission 14 via the fuel cell 50. In this case, the coolant volume flow is adjusted in terms of demand by the supply valve 66 and the return valve 68.

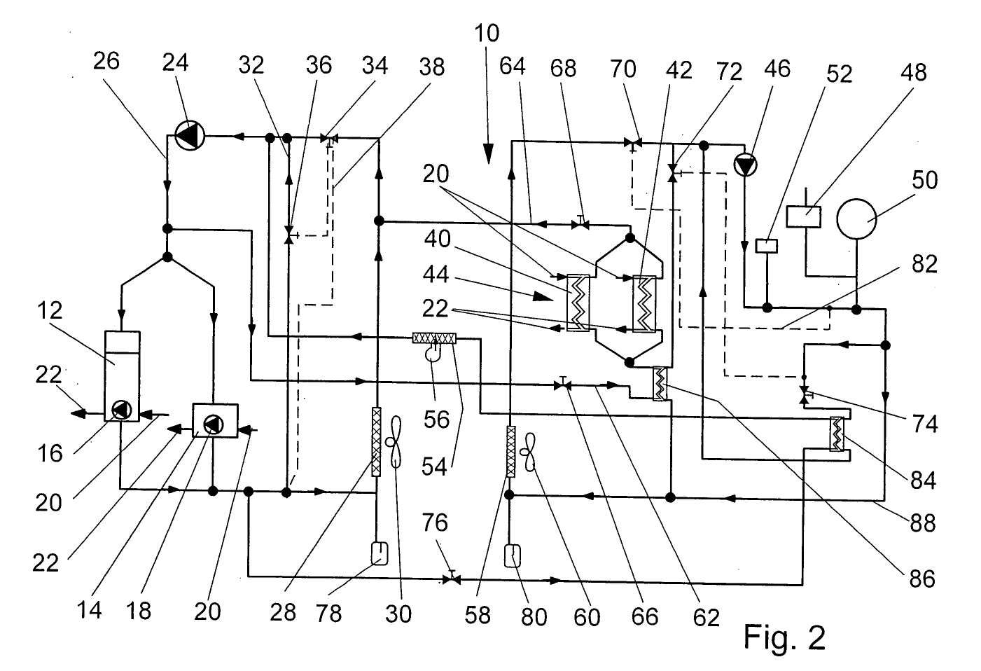

When using de-ionized water, which is currently used preferentially as a coolant for fuel cells due to its property of non-conductivity, the cooling system 88 of the fuel cell 50 is embodied as a closed system in the second partial circuit 44. In this embodiment, along with the fuel cell 50 and an auxiliary pump 26, it features special intermediate heat exchangers 84, 86, which are responsible for de-coupling the different cooling media and must be designed in stainless steel due to the material compatibility with de-ionized water (FIG. 2). The engine oil heat exchanger 40, the transmission oil heat exchanger 42 and the heater heat exchanger 54 can be manufactured of conventional materials. The special intermediate heat exchangers 84, 86 made of stainless steel can be advantageously arranged as desired in the engine compartment and be linked with the various media flows that must be preheated. The intermediate heat exchanger 86 is thermally coupled with the engine oil heat exchanger 40 and the transmission oil heat exchanger 42 in order to facilitate the preheating of the engine or transmission oil also in this embodiment by using the waste heat being generated during the cooling process of the fuel cell 50. The heating of the vehicle passenger compartment before starting the internal combustion engine 12 is also possible in that the heater heat exchanger 54 is coupled with the intermediate heat exchanger 84, wherein a control valve 76 regulates the flow quantity and thereby determines the heat yield.

1. Motor vehicle with an internal combustion engine (12) and an auxiliary power supply device, which includes a fuel cell (50), wherein energy flows and/or media flows of the internal combustion engine (12) and the fuel cell (50) are coupled with one another, in which a cooling and heating circuit (10) is provided, characterized in that the cooling and heating circuit (10) features a first partial circuit (26) and a second partial circuit (44), of which the first (26) is allocated to the internal combustion engine (12) and the second (44) to the fuel cell (50), and that the two partial circuits (26, 44) are connected with one another via a supply line (62) having a supply valve (66) and via return line (64) having a return valve (68).

2. Motor vehicle according to claim 1, characterized in that an engine oil heat exchanger (40) for the internal combustion engine (12) is arranged in the second partial circuit (44), to which an electrically driven engine oil pump (16) conveys the engine oil.

3. Motor vehicle according to claim 1, characterized in that a transmission oil heat exchanger (42) is provided in the second partial circuit (44), to which an electrical driven transmission oil pump (18) conveys transmission oil of a transmission (14).

4. Motor vehicle according to claim 3, characterized in that engine oil heat exchanger (40) and the transmission oil heat exchanger (42) are connected in parallel.

5. Motor vehicle according to claim 1, characterized in that the second partial circuit (44) has an electrically driven auxiliary pump (46), which conveys the coolant through the second partial circuit (44).

6. Motor vehicle according to claim 5, characterized in that a heater heat exchanger (54) is arranged in the second partial circuit (44), whose flow can be regulated via a heater valve (74) that can be triggered electrically.

7. Motor vehicle according to claim 1, characterized in that an auxiliary heater (52) is connected to the second partial circuit (44).

8. Motor vehicle according to claim 1, characterized in that the second partial circuit (44) includes a closed cooling system (88), which is operated with a de-ionized cooling medium and to which the fuel cell (50) and/or the auxiliary heater (52) are attached and in which the additional pump (46) is arranged, wherein the closed cooling system (88) is coupled with the coolant circuit of the engine oil heat exchanger (40) and/or the transmission oil heat exchanger (42) via an intermediate heat exchanger (84).

9. Motor vehicle according to claim 8, characterized in that the heater heat exchanger (54) is allocated to the first partial circuit (26) and its coolant circuit is coupled with the closed cooling system (88) of the second partial circuit (44) via a second intermediate heart exchanger (86).

10. Motor vehicle according to claim 3, characterized in that the second partial circuit (44) has an electrically driven auxiliary pump (46), which conveys the coolant through the second partial circuit (44).

11. Motor vehicle according to claim 10, characterized in that a heater heat exchanger (54) is arranged in the second partial circuit (44), whose flow can be regulated via a heater valve (74) that can be triggered electrically.

12. Motor vehicle according to claim 3, characterized in that an auxiliary heater (52) is connected to the second partial circuit (44).

13. Motor vehicle according to claim 3, characterized in that the second partial circuit (44) includes a closed cooling system (88), which is operated with a de-ionized cooling medium and to which the fuel cell (50) and/or the auxiliary heater (52) are attached and in which the additional pump (46) is arranged, wherein the closed cooling system (88) is coupled with the coolant circuit of the engine oil heat exchanger (40) and/or the transmission oil heat exchanger (42) via an intermediate heat exchanger (84).

14. Motor vehicle according to claim 13, characterized in that the heater heat exchanger (54) is allocated to the first partial circuit (26) and its coolant circuit is coupled with the closed cooling system (88) of the second partial circuit (44) via a second intermediate heart exchanger (86).

15. Motor vehicle according to claim 5, characterized in that an auxiliary heater (52) is connected to the second partial circuit (44).

16. Motor vehicle according to claim 5, characterized in that the second partial circuit (44) includes a closed cooling system (88), which is operated with a de-ionized cooling medium and to which the fuel cell (50) and/or the auxiliary heater (52) are attached and in which the additional pump (46) is arranged, wherein the closed cooling system (88) is coupled with the coolant circuit of the engine oil heat exchanger (40) and/or the transmission oil heat exchanger (42) via an intermediate heat exchanger (84).

17. Motor vehicle according to claim 16, characterized in that the heater heat exchanger (54) is allocated to the first partial circuit (26) and its coolant circuit is coupled with the closed cooling system (88) of the second partial circuit (44) via a second intermediate heart exchanger (86).

18. Motor vehicle according to claim 7, characterized in that the second partial circuit (44) includes a closed cooling system (88), which is operated with a de-ionized cooling medium and to which the fuel cell (50) and/or the auxiliary heater (52) are attached and in which the additional pump (46) is arranged, wherein the closed cooling system (88) is coupled with the coolant circuit of the engine oil heat exchanger (40) and/or the transmission oil heat exchanger (42) via an intermediate heat exchanger (84).

19. Motor vehicle according to claim 18, characterized in that the heater heat exchanger (54) is allocated to the first partial circuit (26) and its coolant circuit is coupled with the closed cooling system (88) of the second partial circuit (44) via a second intermediate heart exchanger (86).

20. Motor vehicle according to claim 2, characterized in that a transmission oil heat exchanger (42) is provided in the second partial circuit (44), to which an electrical driven transmission oil pump (18) conveys transmission oil of a transmission (14).

21. Motor vehicle according to claim 20, characterized in that the second partial circuit (44) has an electrically driven auxiliary pump (46), which conveys the coolant through the second partial circuit (44), characterized in that an auxiliary heater (52) is connected to the second partial circuit (44), and characterized in that the second partial circuit (44) includes a closed cooling system (88), which is operated with a de-ionized cooling medium and to which the fuel cell (50) and/or the auxiliary heater (52) are attached and in which the additional pump (46) is arranged, wherein the closed cooling system (88) is coupled with the coolant circuit of the engine oil heat exchanger (40) and/or the transmission oil heat exchanger (42) via an intermediate heat exchanger (84).
